(19) United States
(12) Patent Application Publication
(10) Pub. No.: US 2019/0299723 A1
(43) Pub. Date: Oct. 3, 2019

(54) INTERNAL FIXING SET FOR A TIRE PRESSURE AUTOMATIC CALIBRATOR

(71) Applicants: Primo Antonio Colussi, Santa Fe (AR); Natalio Domingo Venica, Santa Fe (AR)

(72) Inventors: Primo Antonio Colussi, Santa Fe (AR); Natalio Domingo Venica, Santa Fe (AR)

(21) Appl. No.: 16/371,487

(22) Filed: Apr. 1, 2019

(30) Foreign Application Priority Data
Apr. 3, 2018 (AR) 20180100804

(51) Int. Cl. B60C 23/00

(52) U.S. Cl. CPC B60C 23/003

(57) ABSTRACT

An internal fixing set for a tire pressure automatic calibrator having a pressure air source from which at least a pressure air conduit is extended, said pressure air conduit being mounted on the interior of a vehicle hollow shaft and connected to a flexible tube which in turn is connected to a rotary coupling that distributes air to the vehicle tires, wherein the internal fixing set comprises a piece having a bowl-shaped external section that is attachable to an inner surface of the hollow shaft and an cane-shaped internal section through which interior the pressure air conduit passes and said pressure air conduit is connected to said flexible conduit.

### FIELD OF INVENTION

This invention relates to pressure control, regulation and calibration equipment in a pneumatic pressure arrangement and, more particularly, to an internal fixing set, within a hollow shaft of a vehicle running gear, of the components of a pressure air supply arrangement to calibrate the tire pressure of vehicle wheels.

### PRIOR ART DESCRIPTION

The control, regulation and maintenance of the tire pressure in vehicles in motion have significantly developed in the last years. The tire pressure maintenance has always been an important issue and the transport industry has constantly promoted it as a means to increase the tire lifespan and fuel saving while, in turn, downtime and maintenance costs related to deflated tires are reduced.

There are numerous systems designed for the pressure maintenance of tires in motion, ordinarily called central systems of tire inflation, for example in trucks, some of which are intended for tractors and others, for trailers. Trailer shafts are typically hollow with ends that usually have a through-hole. The hollow shaft provides an advantageous conduit to supply air pressure to the wheel end. Steering shafts and driving shafts are more complex when inflation systems are mounted.

In general, the wheel end set includes a lubrication area between the shaft and the wheel end that is additionally defined by plugging the through-hole in the shaft end and covering the shaft end with a cover at the end of the wheel. The wheel end is supported on the shaft end by means of wheel bearings. The wheel bearings require lubrication and the entirety of the lubrication area is essential for maintaining the operational capacity and lifespan of the wheel end set.

Furthermore, in order to provide pressurized air to the rotary tires, the inflation system includes a rotary union at the same general location as the bearings and necessarily at the same lubrication area between the stationary shaft and the end of the rotating wheel.

In the art, the pressurized air is supplied from the interior of the hollow shaft and through the air hose that is inserted into the shaft. For example, the U.S. Pat. No. 3,276,503 by Kilmarx discloses the use of plastic tubes in a hollow shaft to supply air into the shaft end. Other systems use a conduit in the shaft to carry air to the shaft end by using a fitting in the shaft to supply air into the conduit. In either case, the air pressure in the shaft end is communicated from the stationary shaft to the rotary wheel by using a rotary union.

U.S. Pat. No. 3,276,503 uses a flexible conduit element between the shaft end and the rotary union, U.S. Pat. No. 6,145,559 uses a flexible conduit between the shaft and the rotary union, and U.S. Pat. No. 6,105,645 uses a flexible tube or hose.

U.S. Pat. No. 6,325,124, and is incorporated as if set forth fully herein, which is owned by the same owner of this invention, discloses an inflation system which is focused on improvements in the pneumatic rotor that communicates the fluid pressure between the stationary fluid source and the rotatory tires. This system, which will be generally described below with regard to FIG. 1 in the detailed description, also uses a connection flexible hose or conduit between the fixing set within the shaft and the pneumatic rotor. In all of these cases, the flexible element and its associated joints and connections are very important elements which, in the assembly, disassembly, checking, and control operations, may require to be disassembled and reassembled for which it is imperatively necessary to assemble again each piece and component of the set in the accurate place since the distance between the rotor and the shaft end must always be the same and the flexible conduit length must be accurately in accordance with said distance.

Even when the design of components, such as the internal fixing element, flexible connection hose and rotor, have turned these inflation systems a little bit more efficient, the mounting, disassembly/assembly issues of the system when it is necessary to repair it, or change a tire, dismantle the wheel, etc. have not been approached yet. Said tasks, which may require the complete disassembly of the system, make it necessary to have qualified personnel that does not exist in remote places where vehicles may have a technical problem; consequently, it is necessary to have systems with universal components that may ease the disassembly/assembly operations so that each component is located in a single proper position and properly fits.

### BRIEF DESCRIPTION OF THE INVENTION

It is therefore an object of this invention to provide an internal fixing set for a tire pressure automatic calibrator wherein the fixing set guarantees that, in the assembly/disassembly and reassembly operations of the system, the distance between the pressure air conduit and the internal rotor is maintained thus easing and accelerating the tasks while also providing the system universalization and standardization.

It is a further object of this invention to provide an internal fixing set for a tire pressure automatic calibrator wherein the calibrator comprises a pressure air source from which at least a pressure air conduit extends, said pressure air conduit passing through the interior of a vehicle hollow shaft and having a distal end connected to a flexible tube which in turn is connected to a rotary coupling that distributes air to the vehicle tires, said end of the pressure air conduit being mounted within the hollow shaft by means of the internal fixing set which comprises a piece that has a bowl-shaped external section that is attachable to an inner surface of the hollow shaft and a cane-shaped inner section which has a through-hole through which the distal end of the pressure air conduit extends and said distal end is connected to said flexible conduit within a cavity defined by said bowl-shaped external section.

### BRIEF DESCRIPTION OF THE DRAWINGS

For the purpose of providing more clarity and a better understanding of the subject-matter of the invention, it has been illustrated in several figures, in which the invention has been represented by way of example in a preferred embodiment wherein:

FIG. 1 is a partial sectional perspective view of the assembly of the conventional tire inflation system;

FIG. 2 is a longitudinal sectional view of another inflation system that has an internal fixing set that allows for the mounting of pressure air supply components within a vehicle hollow shaft, and

FIG. 3 is a longitudinal sectional view of an internal fixing set according to the present invention.

### DETAILED DESCRIPTION OF THE INVENTION

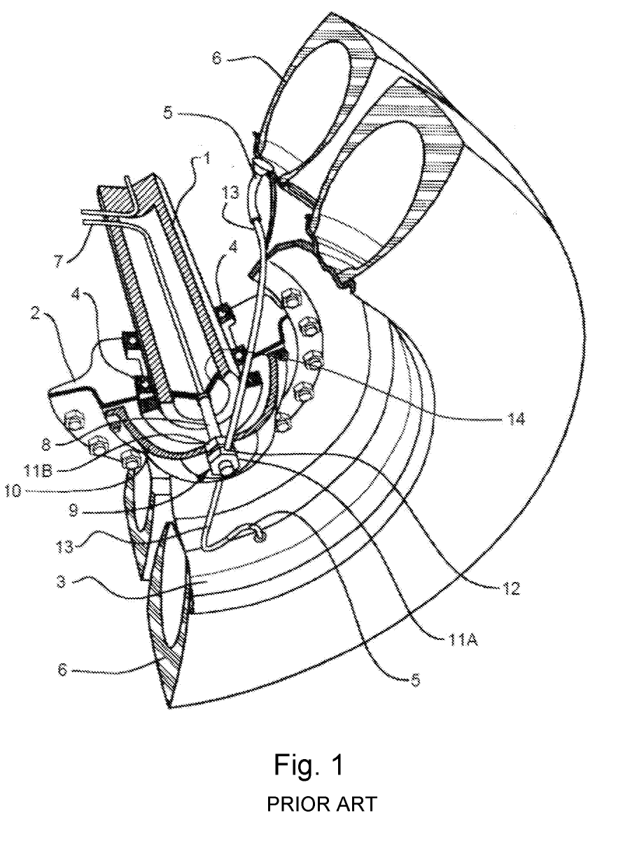

By making reference now to the figures, it may be seen that FIG. 1 is a general view of the mounting of an inflation system or tire calibration in the interior of the stationary hollow shaft of a vehicle. In order to understand where the invention is applied, it is convenient to make a general reference to this conventional system. More particularly, FIG. 1 illustrates the end of a shaft 1 of a motor vehicle, such as a truck, a trailer or a big bus. A wheel hub 2 for mounting a double tire 3 is mounted on the end of shaft 1 by means of a pair of bearings 4. An inflation valve 5 defines a pressure air supply into the interior of the wheel tire 6.

A pressurized air conduit 7 comes from a pressure air source, such as a compressed air tank, enters the interior of the hollow shaft 1 and extends thereinto towards the end where the wheel is mounted, wherein a flexible tube section 8 axially connects it to a rotor or rotary coupling 9 that is mounted on a cover 10 attached to the wheel hub that protects the wheel bearings 4. Furthermore, it may be possible to see the body 11A and 11B of the rotary coupling 9 and the body 11A has two holes 12 connected by means of respective hose sections 13 to the inflation valves 5 of the tires 6. The rotary coupling 9 provides a continuous sealed communication between the air conduit 7, the flexible tube 8 and the inflation valves 5, thus protecting the relative movement between the tires due to the wheel rotation. Finally, the air conduit 7 is attached to the end of the hollow shaft 1 by means of a fixing support 14 to ensure that the conduit remains steady and the connection between it and the flexible tube 8 does not have disassembly risks.

The connection made by the flexible tube 8 between the conduit 7 and the rotor 9 is very significant and when it is necessary to disassemble this connection for repair or maintenance purposes, the distance between the rotor 9 and the end of the conduit 7 must be unalterably kept. When re-assembling the inflation system, an operator faces the problem that the previously removed support 14 must be accurately placed at the same place and generally it is not fulfilled. Only a few very well qualified operators do not commit mistakes when a support 14 must be placed at the right site and ensure an accurate connection between conduit 7 and the flexible tube 8. Likewise, the main problem arises when the operator carries out the maintenance of all of the shaft tips, which generally implies that the rotors become mixed and the distances for the tube 8 are left with different measures as a consequence of which the assembly is inaccurate thus causing air leaks.

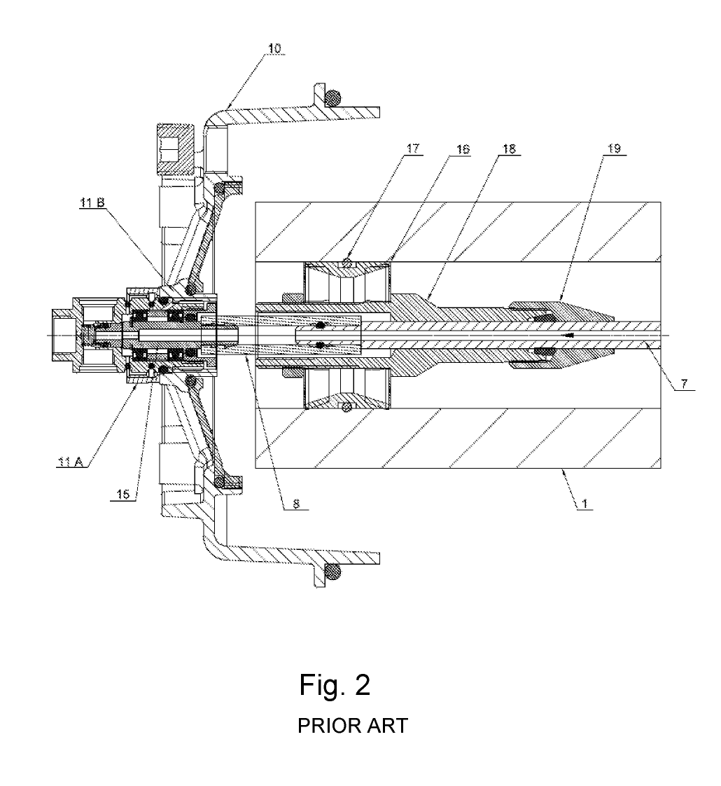

In view of the fact that the support 14 of FIG. 1 corresponds to a very generic illustration, an actual support of the prior art illustrated in FIG. 2 will be subsequently described. In this Figure, not all of the components will be referred to and a description of the internal fixing support part that is related to the field of this invention and the rotor will only be provided. As in the case of FIG. 1, the flexible tube 8 connects the end of the air conduit 7 coming from the interior of shaft 1 to the inner part of the rotor 11B, or internal rotor, within which a piece 15 is located which consists of a sealed sleeve within the rotor 11A, 11B, and to which the tube 8 is connected.

Furthermore, the conduit 7 is mounted on a fixing ring 16, which has an expander set and a toroidal seal 17 for sealing with the interior of the hollow shaft. A mounting pipet 18 having an end nozzle 19 passes through the interior of the fixing ring 16 and conduit 7 passes through the interior of said two pieces. Once the fixing ring 16 has been securely placed, the distance between the end of conduit 7 and the connection end of the sleeve 15 must be the same as the original one. The sleeve 15 will always keep its position since it is attached to the rotor mounted on the cover 10 which is screwed to the hub 2. However, the position of the end of conduit 7 may become altered when the system is disassembled and reassembled because there are not reference elements that indicate where the conduit is to be attached. It is common that the tube 7 is long at the connection time and it may be necessary to cut it, or that it is short and it is necessary to disassemble the system again, which implies a waste of time and an increase in costs.

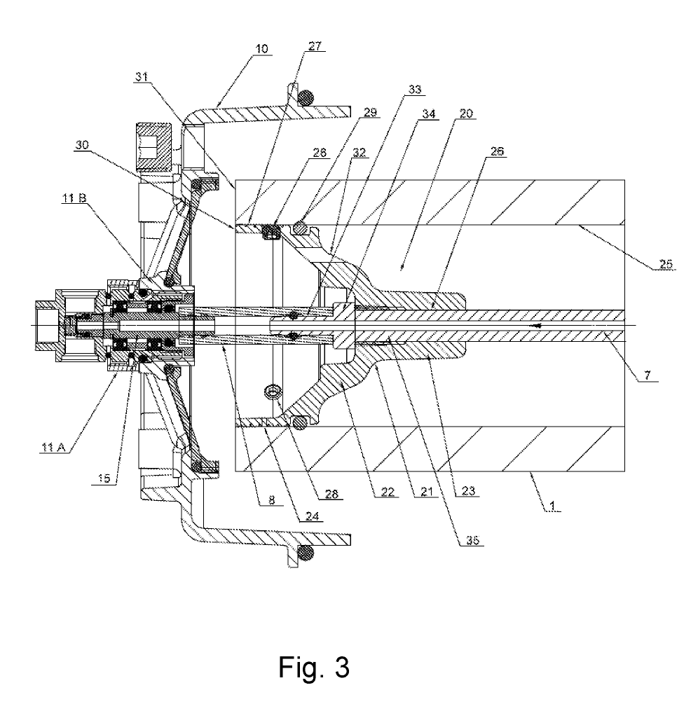

For the purpose of providing a solution to this problem the current state of the art faces, this invention provides a new internal fixing set for a tire pressure automatic calibrator that is illustrated in FIG. 3. This Figure illustrates the components that are common in known inflation systems and the same reference numbers as in FIGS. 1 and 2 for these components have been kept.

According to the invention, the pressure air conduit 7 is attached by means of a new fixing set identified with the general reference 20, which ensures that the end of conduit 7 is always positioned at the same place with regard to the sleeve 15. More particularly, the distal end of conduit 7 always keeps the same distance with regard to the internal rotor 11B.

The fixing set 20 comprises a piece 21 made of any suitable material that is resistant to the conditions under which a vehicle is subjected to in different climates and regions and that has a bowl-shaped external section 22 at which external cylindrical wall 24 is coupled to an internal surface 25 of the hollow shaft 1. The piece 21 also has a cane-shaped internal section 23, which is preferably coaxial with section 22 and has a through-hole 26 through which the distal end 35 of the pressure air conduit 7 passes, and there is a threaded area between the hole 26 and the end 35.

The bowl-shaped external section 22 has an external surface 27 to be coupled to the shaft internal surface 25. This surface is preferably ground in order to avoid oil leaks and ensure a suitable closing of seal 29 within the hollow shaft 1.

For an effective attachment, the bowl-shaped external section 22 has a plurality of radial holes within which set screws 28 are arranged and which are fixed to the inner surface of the hollow shaft 1. The mounting is sealed by means of at least a ring or toroidal-type seal 29. The bowl-shaped section 22 ends in a distal edge 30 that is flush with the distal edge 31 of the hollow shaft 1. In this way, the installer of the inflation system will not need tools, templates or reference gauges to position the fixing set at the right place. It will always be flush with the hollow shaft end thus ensuring that the end of conduit 7 always keeps the same distance with the internal rotor 11B and its components to which it connects by means of the flexible tube 8. Preferably, the bowl-shaped external section 22 will have a venthole 32 located, as shown, in the upper part.

Moreover, the distal end of the pressure air conduit 7 is connected to said flexible conduit 8 by means of a nozzle 33 that is inserted into said hole 26 of the cane-shaped section 23. The nozzle 33 has an end which is connected to the flexible tube and has a stop 34 for said flexible tube 8. In this way, the connection between the conduit 7 and the flexible tube 8 is protected within the cavity defined by said bowl-shaped external section 22 and the distance between conduit 7 and the internal rotor 11B is kept by the fixed position of the stop 34. The bowl section 22 will have a universal external diameter and, in general, adapted to the inner diameters of the shafts that are currently standardized in some countries.

1. An internal fixing set for a tire pressure automatic calibrator, the automatic calibrator having a pressure air source from which at least a pressure air conduit extends, said pressure air conduit passing through the interior of a vehicle hollow shaft and having a distal end that is connected to a flexible tube which in turn is connected to a rotary coupling that distributes air to the vehicle tires, said pressure air conduit end being mounted within the hollow shaft by means of the internal fixing set, the internal fixing set comprising a piece having a bowl-shaped external section attachable to an inner surface of the hollow shaft, and a cane-shaped internal section having a through-hole, the distal end of the pressure air conduit being extended into an interior of said through hole, said distal end being connected to said flexible tube within a cavity defined by said bowl-shaped external section.

2. A fixing set according to claim 1, wherein said bowl-shaped external section has an external surface, the external surface adapted to be fit into the inner surface of the hollow shaft.

3. A fixing set according to claim 1, wherein said bowl-shaped external section has a plurality of radial holes, and an arrangement of set screws that are fixed in the inner surface of the hollow shaft, a respective set screw being received in a respective radial hole.

4. A fixing set according to claim 1, wherein a seal is disposed between said bowl-shaped external section and said inner surface of the hollow shaft.

5. A fixing set according to claim 1, wherein said distal end is connected to a nozzle, the nozzle being inserted into said hole of the cane-shaped section and the nozzle having an end that is connected to the flexible tube and a stop for said flexible tube.

6. A fixing set according to claim 1, wherein said bowl-shaped external section has a venthole.

7. A fixing set according to claim 1, wherein said bowl-shaped external section is coaxial with said cane-shaped section.

8. A fixing set according to claim 5, wherein said flexible tube has a first end and a second end, and is connected at said first end to said nozzle and at said second end to a sleeve of the rotary coupling, the fixing set arrangement of the shaft and a distal edge of the fixing set maintaining a distance between the sleeve and the nozzle always to be the same.
